(19) United States
(12) Patent Application Publication
(10) Pub. No.: US 2012/0136659 A1
(43) Pub. Date: May 31, 2012

(54) APPARATUS AND METHOD FOR PREPROCESSING SPEECH SIGNALS

(75) Inventors: Byung-Ok Kang, Gyeryong-si (KR); Hwa-Jeon Song, Daejeon (KR); Ho-Young Jung, Daejeon (KR); Sung-Joo Lee, Daejeon (KR); Jeon-Gue Park, Seoul (KR); Yun-Keun Lee, Daejeon (KR)

(73) Assignee: ELECTRONICS AND TELECOMMUNICATIONS RESEARCH INSTITUTE, Daejeon (KR)

(21) Appl. No.: 13/302,480

(22) Filed: Nov. 22, 2011

(30) Foreign Application Priority Data
Nov. 25, 2010 (KR) 10-2010-0118310

(51) Int. Cl. G10L 15/00

(52) U.S. Cl. 704/231; 704/E15.001

(57) ABSTRACT

Disclosed herein are an apparatus and method for preprocessing speech signals to perform speech recognition. The apparatus includes a voiced sound interval detection unit, a preprocessing method determination unit, and a clipping signal processing unit. The voiced sound interval detection unit detects a voiced sound interval including a voiced sound signal in a voice interval. The preprocessing method determination unit detects a clipping signal present in the voiced sound interval. The clipping signal processing unit extracts signal samples adjacent to the clipping signal, and performs interpolation on the clipping signal using the adjacent signal samples.

### CROSS REFERENCE TO RELATED APPLICATION

This application claims the benefit of Korean Patent Application No. 10-2010-0118310, filed on Nov. 25, 2010, which is hereby incorporated by reference in its entirety into this application.

### BACKGROUND OF THE INVENTION

1. Technical Field

The present invention relates generally to an apparatus and method for preprocessing speech signals and, more particularly, to an apparatus and method for preprocessing speech signals, which correct and/or perform interpolation on speech signals of abnormal sizes that are input in a mobile environment, thereby increasing the performance of speech recognition.

2. Description of the Related Art

In a mobile environment, there is the strong possibility of speech recognition being inaccurate due to a surrounding environment, the difference in the performance of speech recognition devices, the low skill of a user, etc.

In particular, in speech recognition, when a speech signal of an abnormally large size is input due to the Rombard effect which occurs in an environment where the surrounding noise is high, a mobile device for which a high input gain was set, or the like, a clipping phenomenon may occur in a speech signal. Furthermore, the occurrence of the phenomenon of a speech signal being clipped causes the speech signal to be distorted, which becomes the cause of the performance of speech recognition being lowered.

In contrast, in speech recognition, when a user and a speech recognition device are separated by a long distance or when a speech signal of an abnormally small size is input due to the personal characteristics of a user, the characteristic information of the signal used for speech recognition is not exhibited. Accordingly, there may arise the problem of the distinctiveness of a speech signal input to a speech recognition device being low.

### SUMMARY OF THE INVENTION

Accordingly, the present invention has been made keeping in mind the above problems occurring in the prior art, and an object of the present invention is to provide an apparatus and method for preprocessing speech signals, which perform interpolation on and restore speech signals of abnormal sizes that are input in a mobile environment, thereby increasing the performance of speech recognition.

Another object of the present invention is to provide an apparatus and method for preprocessing speech signals, which divide an input signal into a voiced sound interval and an unvoiced interval and into at least one closed glottis interval and at least one open glottis interval and perform speech preprocessing, thereby enabling efficient and systematic speech signal preprocessing.

Still another object of the present invention is to provide an apparatus and method for preprocessing speech signals, which correct speech signals of abnormal sizes within the allowable range of digital signal processing, thereby minimizing the distortion of the speech signals to be recognized.

In order to accomplish the above object, the present invention provides an apparatus for preprocessing speech signals to perform speech recognition, including a voiced sound interval detection unit for detecting a voiced sound interval including a voiced sound signal in a voice interval; a preprocessing method determination unit for detecting a clipping signal present in the voiced sound interval; and a clipping signal processing unit for extracting signal samples adjacent to the clipping signal and performing interpolation on the clipping signal using the adjacent signal samples.

The clipping signal processing unit may include an adjacent signal extraction unit for extracting the signal samples adjacent to the clipping signal; an estimation parameter calculation unit for calculating an estimation parameter that is used to perform interpolation on the clipping signal, using the adjacent signal samples and a linear estimation method; and a clipping signal interpolation unit for performing interpolation on the clipping signal using the estimation parameter.

The apparatus may further include a period detection unit for detecting periodicity of the speech signal by detecting a highest point of the speech signal in the voiced sound interval.

The adjacent signal extraction unit may extract the adjacent signal samples included in a periodic interval identical to an interval in which the clipping signal is included, based on information about the periodicity detected by the period detection unit.

The preprocessing method determination unit may detect a low-energy speech signal that is present in the voiced sound interval and has a signal energy value lower than a preset threshold energy value, and a low-energy utterance processing unit for improving a signal-to-noise ratio of the low-energy speech signal by restoring the low-energy speech signal may be further included.

The apparatus may further include a period detection unit for detecting periodicity of the speech signal by detecting a highest point of the speech signal in the voiced sound interval.

The low-energy utterance processing unit may include a window function generation unit for generating a window function that is used to divide the voiced sound interval into at least one closed glottis interval and at least one open glottis interval and process them, using information about the periodicity detected by the period detection unit; and a periodic characteristic enhancement unit for restoring the low-energy speech signal by increasing voice energy of the closed glottis interval and attenuating voice energy of the open glottis interval using the window function.

In order to accomplish the above object, the present invention provides a method of preprocessing speech signals to perform speech recognition, including receiving an input signal including a speech signal; detecting a voiced sound interval including a voiced sound signal in the input signal; detecting a clipping signal present in the voiced sound interval; and performing interpolation on the clipping signal using signal samples adjacent to the clipping signal.

The performing may include extracting the signal samples adjacent to the clipping signal; calculating an estimation parameter that is used to perform interpolation on the clipping signal, using the adjacent signal samples and a linear estimation method; and performing interpolation on the clipping signal using the estimation parameter.

The method may further include detecting periodicity of the speech signal by detecting a highest point of the speech signal in the voiced sound interval.

The extracting the adjacent signal samples may include extracting the adjacent signal samples included in a periodic interval identical to an interval in which the clipping signal is included, based on information about the periodicity.

The method may further include determining whether a low-energy speech signal that has a signal energy value lower than a preset threshold energy value is detected in the voiced sound interval; and improving a signal-to-noise ratio of the low-energy speech signal by restoring the low-energy speech signal.

The method may further include detecting periodicity of the speech signal by detecting a highest point of the speech signal in the voiced sound interval.

The restoring may include generating a window function that is used to divide the voiced sound interval into at least one closed glottis interval and at least one open glottis interval and process them, using information about the periodicity; and restoring the low-energy speech signal by increasing voice energy of the closed glottis interval and attenuating voice energy of the open glottis interval using the window function.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of an apparatus for preprocessing speech signals to perform speech recognition according to the present invention; and

FIG. 2 is a flowchart illustrating a method of preprocessing speech signals to perform speech recognition according to the present invention.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

The configuration and operation of an apparatus 1000 for preprocessing speech signals to perform speech recognition according to the present invention will now be described in detail.

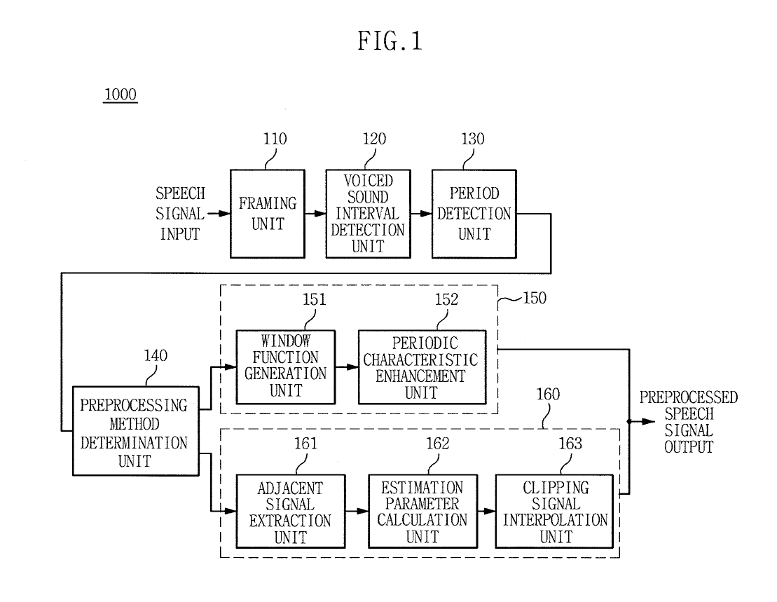

FIG. 1 is a block diagram illustrating the configuration of the apparatus 1000 for preprocessing speech signals to perform speech recognition according to the present invention.

Referring to FIG. 1, the apparatus 1000 for preprocessing speech signals to perform speech recognition according to the present invention includes a framing unit 110, a voiced sound interval detection unit 120, a preprocessing method determination unit 140, and a clipping signal processing unit 160. Furthermore, the apparatus 1000 for preprocessing speech signals to perform speech recognition according to the present invention may further include a period detection unit 130, and a low-energy utterance processing unit 150.

The framing unit 110 divides an input signal into successive sectional signals by the basic time unit of speech signal preprocessing. The framing unit 110 extracts voice intervals, that is, the basic units of speech recognition preprocessing, while shifting along the input signal at regular intervals of unit blocks of tens of millisecond.

The voiced sound interval detection unit 120 detects a voiced sound interval including a voiced sound signal in each of the voice intervals. A speech signal may be divided into voiced sound intervals, unvoiced sound intervals, and mute/noise intervals. Among these, each voiced sound interval includes a speech signal having a relatively high-energy value. Accordingly, there is the strong possibility of a clipping signal being present in the voiced sound interval. Furthermore, there is also the strong possibility of signal information for speech recognition, such as periodicity, being lost in the voiced sound interval if an input speech signal is low.

The period detection unit 130 detects the periodicity of the speech signal by detecting the highest point of the speech signal in the voiced sound interval. In particular, the voiced sound interval includes a plurality of periodic intervals having a fundamental frequency that varies depending on gender and personal preference. The period detection unit 130 detects periodic intervals having the fundamental frequency. The periodicity information detected by the period detection unit 130 may be used to interpolate a clipping signal and restore a low-energy speech signal, which will be performed later.

The preprocessing method determination unit 140 detects a low-energy speech signal that is present in the voiced sound interval. Here, the low-energy speech signal is a speech signal that has a signal energy value less than a preset threshold energy value. The preprocessing method determination unit 140 causes the subsequent low-energy utterance processing unit 150 to operate if a low-energy speech signal is detected in the voiced sound interval. Furthermore, the preprocessing method determination unit 140 detects a clipping signal in the voiced sound interval. Here, the clipping signal corresponds to a part of the speech signal in which the intrinsic values of a plurality of successive signal samples have been lost and the samples have a fixed constant value. The preprocessing method determination unit 140 may cause the subsequent clipping signal processing unit 160 to operate if a clipping signal is detected in the voiced sound interval.

The low-energy utterance processing unit 150 improves the signal-to-noise ratio (SNR) of the low-energy speech signal by restoring the low-energy speech signal. The low-energy utterance processing unit 150 may include a window function generation unit 151, and a periodic characteristic enhancement unit 152.

The window function generation unit 151 generates a window function that is used to divide a voiced sound interval into a closed glottis interval and an open glottis interval and to process them. Furthermore, the window function generation unit 151 may generate a window function using the periodicity information of the speech signal that has been detected by the period detection unit 130.

The periodic characteristic enhancement unit 152 restores a low-energy speech signal by increasing the voice energy of the closed glottis interval and attenuating the voice energy of the open glottis interval using the window function.

The maximum energy of the voiced sound signal occurs in the closed glottis interval. Meanwhile, the energy of the voiced sound signal is abruptly attenuated in the open glottis interval. That is, in the voiced sound interval, the closed glottis interval and the open glottis interval are repeated at the fundamental frequency. When a low-energy utterance, that is, a low-energy speech signal is generated, a considerable part of the periodicity information of a speech signal is lost. In particular, a low-energy speech signal in a noise environment has the same even signal shape as a signal in the unvoiced interval. In contrast, the energy of a noise component has almost the same energy in a short interval. Accordingly, the periodicity of a speech signal in the voiced sound interval can be clarified by increasing voice energy in the closed glottis interval and attenuating voice energy in the open glottis interval. Furthermore, the signal-to-noise ratio SNR of the speech signal can be improved.

The clipping signal processing unit 160 extracts signal samples adjacent to a clipping signal, and performs interpolation on the clipping signal using the adjacent signal samples. The clipping signal processing unit 160 performs interpolation on the clipping signal in the voiced sound interval using linear prediction based on the half-periodic signal characteristic of the voiced sound interval. The clipping signal processing unit 160 may include an adjacent signal extraction unit 161, an estimation parameter calculation unit 162, and a clipping signal interpolation unit 163.

The adjacent signal extraction unit 161 extracts signal samples adjacent to the clipping signal. That is, the adjacent signal extraction unit 161 extracts adjacent signal samples included in a periodic interval, such as that of a clipping signal, based on the periodicity information detected by the period detection unit 130.

The estimation parameter calculation unit 162 calculates an estimation parameter that will be used to perform interpolation on the clipping signal, using the adjacent signal samples. That is, the estimation parameter calculation unit 162 establishes a linear relation using the adjacent signal samples as input, and calculates an estimation parameter aᵢ using a least square algorithm.

The clipping signal interpolation unit 163 performs interpolation on the clipping signal using the estimation parameter. That is, the clipping signal interpolation unit 163 performs interpolation on the clipping signal using the estimation parameter αᵢ calculated by the estimation parameter calculation unit 162.

A detailed method of performing interpolation on a clipping signal using the clipping signal processing unit 160 will now be described. First, the adjacent signal extraction unit 161 extracts (N-p) adjacent signal samples that are included in the same periodic interval period as the clipping signal and are adjacent to the clipping signal. Furthermore, the estimation parameter calculation unit 162 establishes a linear relation, such as the following Equation 1, using the adjacent signal samples, obtained by the adjacent signal extraction unit 161, as input. Thereafter, the estimation parameter calculation unit 162 obtains the estimation parameter αᵢ using least square calculation.

$$( \begin{matrix}{x}_{1} \\ {x}_{2} \\ ⋮ \\ ⋮ \\ {x}_{N - p}\end{matrix} ) = ( \begin{matrix}{x}_{2} & {x}_{3} & … & … & {x}_{p + 1} \\ {x}_{3} & {x}_{4} & … & … & {x}_{p + 2} \\ … & … & … & … & … \\ … & … & … & … & … \\ {x}_{N - p + 1} & {x}_{N - p + 2} & … & … & {x}_{N}\end{matrix} ) ( \begin{matrix}{α}_{1} \\ {α}_{2} \\ ⋮ \\ ⋮ \\ {α}_{p}\end{matrix} ) \qquad ( 1 )$$

Furthermore, the clipping signal interpolation unit 163 performs interpolation on a signal sample in which clipping occurred, using the following Equation 2:

$${x}_{n} = {\sum }_{k = 1}^{p} {α}_{k} {x}_{n - k} \qquad ( 2 )$$

A method of preprocessing speech signals to perform speech recognition according to the present invention will be described below.

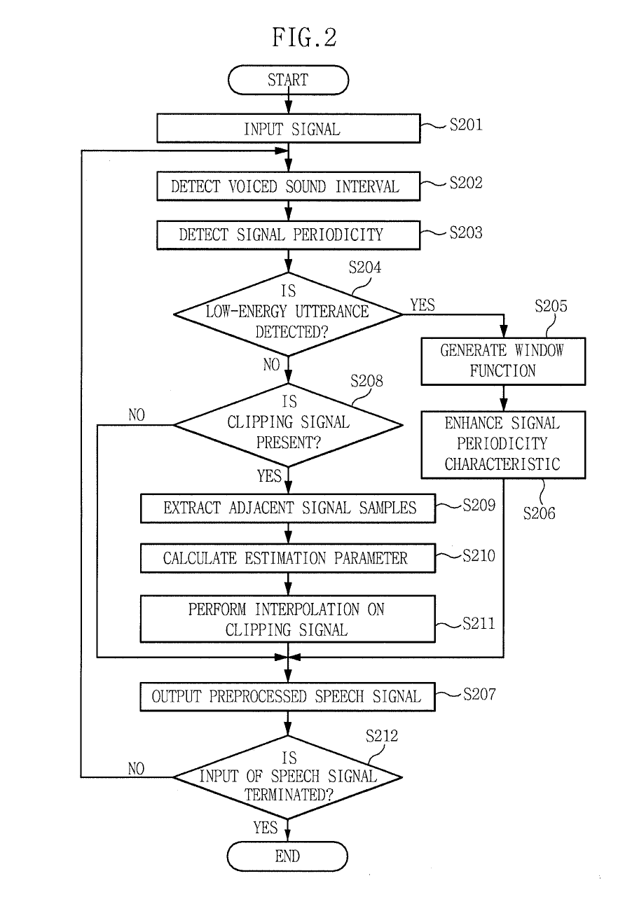

FIG. 2 is a flowchart illustrating the method of preprocessing speech signals to perform speech recognition according to the present invention.

Referring to FIG. 2, in the method of preprocessing speech signals to perform speech recognition according to the present invention, first, an input signal including a speech signal is input at step S201.

Thereafter, the input signal input at step S201 is divided into successive sectional signals by the basic time unit of speech signal preprocessing, and a voiced sound interval including a voiced sound signal is detected in each sectional signal at steps S202.

Furthermore, the periodicity of the speech signal is detected in the voiced sound interval extracted at step S202 by detecting the highest point of the speech signal at step S203.

Thereafter, it is determined whether a low-energy utterance, that is, a low-energy speech signal, is present in the voiced sound interval at step S204. Here, the low-energy speech signal is a speech signal that has a signal energy value lower than a preset threshold energy value.

If, as a result of the determination at step S204, it is determined that a low-energy speech signal is present, a window function that is used to divide a voiced sound interval into a closed glottis interval and an open glottis interval and to process them is generated at step S205. Here, the window function may be generated using the periodicity information of the speech signal. At step S206, the low-energy speech signal is restored by increasing the voice energy of the closed glottis interval and attenuating the voice energy of the open glottis interval using the window function generated at step S205. The speech signal restored at steps S205 and S206, that is, a preprocessed speech signal, is output to the outside at step S207.

If, as a result of the determination at step S204, it is determined that a low-energy speech signal is not present, it is determined whether a clipping signal is detected in a voiced sound interval at step S208.

If, as a result of the determination at step S208, it is determined that a clipping signal is detected, signal samples adjacent to the clipping signal are extracted at step S209. In this case, adjacent signal samples in the same periodic interval as the clipping signal may be extracted based on information about the periodicity of the speech signal. Thereafter, an estimation parameter that is used to perform interpolation on the clipping signal is calculated using the adjacent signal samples at step S210. Interpolation is performed on the clipping signal using the estimation parameter at step S211. The speech signal on which the interpolation has been performed at steps S209, S210 and S211, that is, a preprocessed speech signal, is output to the outside at step S207.

If, as a result of the determination at step S208, it is determined that a clipping signal is not detected, the speech signal is output without modification at step S207.

After the preprocessed speech signal has been output, it is determined whether a new speech signal is input at step S212. If a new speech signal is input, the process returns to step S202 and performs the preprocessing of the new speech signal. If it is determined that a new speech signal is not input, the overall process of the method of preprocessing speech signals is terminated.

Accordingly, the present invention has the advantage of increasing the performance of speech recognition because it is configured to perform interpolation on and restore speech signals of abnormal sizes that are input in a mobile environment. In particular, the present invention is configured to effectively preprocess a speech signal not only when a clipping signal is generated due to the high energy of a speech signal but also when a low-energy utterance generated, that is, the energy of a speech signal is low, thereby increasing the performance of speech recognition.

The present invention has the advantage of enabling efficient and systematic speech signal preprocessing because it is configured to divide an input signal into a voiced sound interval and an unvoiced interval and into at least one closed glottis interval and at least one open glottis interval and to perform speech preprocessing.

The present invention has the advantage of minimizing the distortion of speech signals to be recognized because it is configured to correct speech signals of abnormal sizes within the allowable range of digital signal processing.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for preprocessing speech signals to perform speech recognition, comprising:
a voiced sound interval detection unit for detecting a voiced sound interval including a voiced sound signal in a voice interval;
a preprocessing method determination unit for detecting a clipping signal present in the voiced sound interval; and
a clipping signal processing unit for extracting signal samples adjacent to the clipping signal and performing interpolation on the clipping signal using the adjacent signal samples.

2. The apparatus as set forth in claim 1, wherein the clipping signal processing unit comprises:
an adjacent signal extraction unit for extracting the signal samples adjacent to the clipping signal;
an estimation parameter calculation unit for calculating an estimation parameter that is used to perform interpolation on the clipping signal, using the adjacent signal samples and a linear estimation method; and
a clipping signal interpolation unit for performing interpolation on the clipping signal using the estimation parameter.

3. The apparatus as set forth in claim 2, further comprising a period detection unit for detecting periodicity of the speech signal by detecting a highest point of the speech signal in the voiced sound interval.

4. The apparatus as set forth in claim 3, wherein the adjacent signal extraction unit extracts the adjacent signal samples included in a periodic interval identical to an interval in which the clipping signal is included, based on information about the periodicity detected by the period detection unit.

5. The apparatus as set forth in claim 1, wherein the preprocessing method determination unit detects a low-energy speech signal that is present in the voiced sound interval and has a signal energy value lower than a preset threshold energy value;
further comprising a low-energy utterance processing unit for improving a signal-to-noise ratio of the low-energy speech signal by restoring the low-energy speech signal.

6. The apparatus as set forth in claim 5, further comprising a period detection unit for detecting periodicity of the speech signal by detecting a highest point of the speech signal in the voiced sound interval.

7. The apparatus as set forth in claim 6, wherein the low-energy utterance processing unit comprises:
a window function generation unit for generating a window function that is used to divide the voiced sound interval into a glottis interval and an open glottis interval and process the glottis interval and the open glottis interval, using information about the periodicity detected by the period detection unit; and
a periodic characteristic enhancement unit for restoring the low-energy speech signal by increasing voice energy of the closed glottis interval and attenuating voice energy of the open glottis interval using the window function.

8. A method of preprocessing speech signals to perform speech recognition, comprising:
receiving an input signal including a speech signal;
detecting a voiced sound interval including a voiced sound signal in the input signal;
detecting a clipping signal present in the voiced sound interval; and
performing interpolation on the clipping signal using signal samples adjacent to the clipping signal.

9. The method as set forth in claim 8, wherein the performing comprises:
extracting the signal samples adjacent to the clipping signal;
calculating an estimation parameter that is used to perform interpolation on the clipping signal, using the adjacent signal samples and a linear estimation method; and
performing interpolation on the clipping signal using the estimation parameter.

10. The method as set forth in claim 9, further comprising detecting periodicity of the speech signal by detecting a highest point of the speech signal in the voiced sound interval.

11. The method as set forth in claim 10, wherein the extracting the adjacent signal samples comprises extracting the adjacent signal samples included in a periodic interval identical to an interval in which the clipping signal is included, based on information about the periodicity.

12. The method as set forth in claim 8, further comprising:
determining whether a low-energy speech signal that has a signal energy value lower than a preset threshold energy value is detected in the voiced sound interval; and
improving a signal-to-noise ratio of the low-energy speech signal by restoring the low-energy speech signal.

13. The method as set forth in claim 12, further comprising detecting periodicity of the speech signal by detecting a highest point of the speech signal in the voiced sound interval.

14. The method as set forth in claim 13, wherein the restoring comprises:
generating a window function that is used to divide the voiced sound interval into a closed glottis interval and an open glottis interval and process the glottis interval and the open glottis interval, using information about the periodicity; and
restoring the low-energy speech signal by increasing voice energy of the closed glottis interval and attenuating voice energy of the open glottis interval using the window function.
